(19) United States
(12) Patent Application Publication
(10) Pub. No.: US 2005/0058878 A1
(43) Pub. Date: Mar. 17, 2005

(54) Method for the production of bipolar plates or electrode plates for fuel cells or electrolyzer stacks, method for the production of a stack of bipolar plates or electrode plates, as well as a bipolar plate or electrode plate

(75) Inventor: Johann Martin, Solms (DE)

Correspondence Address: WILLIAM COLLARD;COLLARD & ROE, P.C., 1077 NORTHERN BOULEVARD, ROSLYN, NY, 11576, US

(73) Assignee: Huttenberger Produktionstechnik Martin GmbH

(21) Appl. No.: 10/953,616

(22) Filed: Sep. 16, 2004

(30) Foreign Application Priority Data
Sep. 17, 2003 (DE) 103 43 267.1
Aug. 2, 2004 (EP) 04/018244.6

(51) Int. Cl. H01M 8/02; C25B 9/00; B29C 45/00

(52) U.S. Cl. 429/34; 204/279; 264/328.1; 264/328.17

(57) ABSTRACT

A method for the production of bipolar plates or electrode plates for fuel cells or electrolyzer stacks is provided, whereby the bipolar plates or electrode plates have at least one punched band and/or at least one punched blank that are punched from a flat material made of a conductive and corrosion-resistant metal and surrounded with plastic, by means of injection molding. A method for the production of a stack of bipolar plates or electrode plates is also provided. The bipolar plate or electrode plate has strips of a punched band material made of a conductive and corrosion-resistant metal.

### CROSS REFERENCE TO RELATED APPLICATIONS

Applicant claims priority under 35 U.S.C. §119 of German Application No. 103 43 267.1 filed Sep. 17, 2003 and European Application No. 04/018244.6 filed Aug. 2, 2004.

### BACKGROUND OF THE INVENTION

1. Field of the Invention

The present invention relates to a method for the production of bipolar plates or electrode plates for fuel cells or electrolyzer stacks. The invention also relates to a method for the production of a stack of bipolar plates or electrode plates, as well as a bipolar plate or electrode plate.

2. The Prior Art

Bipolar plates or electrode plates for fuel cell stacks are used for generating electricity and heat or for electrolyzer stacks for generating hydrogen and oxygen. Because the structure is fundamentally the same, only a fuel cell will be discussed hereinafter. However, an electrolyzer stack is also meant.

A significant hindrance for a greater use of fuel cells (membrane fuel cell (PEM—proton exchange membrane) or direct methanol fuel cell (DMFC)) is the time-consuming and complicated production of the fuel cell stack, which is composed of bipolar plates.

According to the state of the art, bipolar plates made of metal or graphite are currently used. The openings and channels for the introduction and distribution of the reaction agents and the coolant are produced by means of cost-intensive methods.

Pressing methods for the production of structured bipolar plates, with subsequent finishing, are also part of the state of the art.

There are mixtures of graphite and plastic (composite) for injection molding. In this connection, the channel structure and the passages for the gas feed lines are completely injection-molded.

Injection molding using these graphite/plastic mixtures has the disadvantage that these mixture are relatively viscous. Therefore it is difficult if not impossible to injection-mold small structures with these mixtures.

Bipolar plates that are produced only from sheet metal are also part of the state of the art. Sealing takes place using flat seals or seals that are injection-molded on.

All of the bipolar plates that are part of the state of the art have the disadvantage that they are very complicated and expensive to produce. Furthermore, small structures, in particular, for fuel cells that take up little space, cannot be produced or cannot be easily produced.

### SUMMARY OF THE INVENTION

It is an object of the present invention to provide a method for the production of bipolar plates or electrode plates for fuel cells or electrolyzer stacks. It is a further object to provide a method for the production of a stack of bipolar plates or electrode plates, as well as a bipolar plate or electrode plate that are extremely advantageous in their production and furthermore can be produced with spatially small dimensions.

These and other objects are accomplished by means of a method according to one aspect of the invention for the production of bipolar plates or electrode plates for fuel cells or electrolyzer stacks and by means of a bipolar plate or electrode plate according to another aspect of the invention.

According to the method, the bipolar plate or electrode plate has at least one punched band and/or at least one punched blank that is punched from a flat material made of a conductive and corrosion resistant metal. The flat material is incised or cut in strip shape, using a punching process, the strips are pushed out of a center position, and an injection-molding process is carried out, in a manner such that the strips are held in place by plastic.

In accordance with another aspect, a bipolar plate or electrode plate is provided having at least one punched band and/or at least one punched blank, which has strips of punched flat material made of a conductive and corrosion-resistant material. The at least one punched band or the at least one punched blank is configured to be at least partially surrounded by plastic, by means of injection molding, whereby channels for reaction agents are formed by the plastic.

According to the method according to the invention for the production of bipolar plates or electrode plates for fuel cells or electrolyzer stacks, the bipolar plate or electrode plate has at least one punched band and/or at least one punched blank that is punched from a flat material made of a conductive and corrosion-resistant metal. As a result, it is possible to produce the required strips without waste, with great precision, from the flat material, in the region of the channels (flow field). In this connection, the contact areas with the anodes and the cathodes, respectively, are alternately displaced to both sides, out of the original plane.

Flat material is understood to mean punched blanks, strips, or band material. For the sake of simplicity, the following explanations are presented with regard to band material. However, the use of punched blanks and strips is also meant.

In another method step, the at least one punched band and/or the at least one punched blank is surrounded at least partially with plastic, by means of injection molding. The surrounding plastic is formed so that channels for passing through reaction agents are formed with the plastic, between the punched conductor tracks.

The metal strips are merely partially surrounded by means of injection molding, so that the metal strips can be arranged with direct contact to a gas diffusion layer of a membrane, when arranging the bipolar plate or electrode plate.

It is advantageous if the band material is incised or cut in strip shape in a first method step. Subsequently, the strips are pushed out of a center position, and after that, the injection-molding process is carried out.

For easier handling of the strips, the strips are merely partially incised during the punching process and/or connection gates are formed. In this way, the band material forms a cohesive structure with the strips. This structure can be subjected to surface treatment, for example, after the punching process and before the injection-molding process. In this connection, it is possible to undertake partial or full-area gold plating of the surface, in order to achieve greater performance with the fuel cell.

During the injection-molding process, the strips are pushed into their end position and partially surrounded there, by means of injection molding. In this way, the strips are given a fixed position in the plastic which, at the same time, forms the channels for the reaction agents.

The strips may be pressed against the top and bottom of the injection-molding die by means of the injection-molding pressure. It is also possible to perform a corresponding movement of the injection-molding die inserts during the injection-molding process. In this connection, pressing the metal strips against the surfaces of the injection-molding die inserts that form the injection-molding space, which are configured in comb-like manner, can take place in the first step.

In this way, it is possible to apply a very thin plastic layer to the metal strip. Thicknesses of 2/10 or 3/10 of a millimeter are possible, for example.

A particular advantage of the method according to an embodiment of the invention lies in configuring the electrode plate as a finished plate, with pre-finished or completely finished channels for carrying the reaction agents.

It is possible to produce a stack from these bipolar plates or electrode plates, in simple manner, in that the plates connected with one another to form the stack are stacked on top of one another by means of 180° bends, in each instance. A membrane carrying at least one gas diffusion layer is arranged between the plates.

It is advantageous if the progression of the channels in a flow field is arranged to be parallel between the plate planes that lie opposite one another. In this way, two punched tracks or punched blanks that lie opposite one another and are formed from the band material and are partially surrounded with plastic by means of injection-molding, in each instance, are arranged to rest with pressure on both sides of the membrane that carries the gas diffusion layer.

The finished plates (punched tracks or punched blanks surrounded with plastic by means of injection-molding) are pressed against the membrane and against the gas diffusion layers with a certain contact pressure. The gas diffusion layer, for example, is supposed to be compressed by approximately 40%. The invention is characterized in that the electrode plates can be produced with very great precision, i.e. with an accuracy of more than 5/100 millimeters. In this way, in turn, it is possible to apply the required pressure very uniformly.

This pressure must be achieved in relatively precise manner. If the pressure is too low, the transition resistance is too great. If the pressure is too high, no gases can diffuse through the gas diffusion layer, so that throttling occurs.

It is advantageous if a plastic frame with a seal (2K technique) is injection-molded onto the at least one punched band and/or the at least one punched blank. The result achieved by means of the plastic frame with the seal injection-molded onto it is that the fuel cell is gas-tight.

If metal plates project out of the plastic frame, the fuel cell can also be arranged, for example, in a heat exchanger system. For example the fuel cell can be arranged in a hot water storage tank of the heating system of a house. The cooling medium of the heat exchanger system is hereby heated directly, since the energy is converted about 50% into electricity and 50% into heat in the fuel cell. Excess heat can be advantageously carried off in this manner. It is advantageous if air or an electrically non-conductive cooling medium (glycol, for example) is provided in the heat exchanger system.

Carrying off the heat in this manner is also possible in the case of other applications, for example by way of a fan.

Depending on the method of folding the bipolar plates or electrode plates, the bipolar plates or electrode plates may be arranged in electrical series and/or in a parallel circuit.

In a stack, several bipolar plates or several electrode plates are arranged on top of one another, with a membrane that in turn carries gas diffusion layers lying between them.

It is advantageous if a stack is built up by lining up identical segments, whereby one segment of an electrode plate has distributor channels as well as connectors for the reaction agents and a membrane/electrode assembly (MEA). The membrane/electrode assembly of a first segment forms the gas-tight and electrically insulating but proton-conductive delimitation of the second segment. The membrane/electrode assembly of the second segment forms the gas-tight and electrically insulating but proton-conductive delimitation of the third segment, and so on.

It is advantageous if end plates are arranged at both ends of the electrode stack, between which the individual lined-up segments with their seals are clamped. It is advantageous if the end plates have connectors for passing the reaction agents in and out.

The bipolar plate or electrode plate according to the invention has at least one punched strip band and/or at least one punched blank, which is made up of strips of punched band material made from a conductive and corrosion-resistant material. According to a preferred embodiment, stainless steel or copper having a corrosion protection layer is used.

If stainless steel is used, this material can be gold plated, for example. It is also possible to use a stainless steel that is not gold plated and is also not surface-coated in any other manner.

The combination of metal and plastic, according to the invention, is particularly advantageous. The metal strips are partially surrounded with plastic, by means of injection molding, whereby channels for the reaction agents are formed by the plastic. The punched bands or punched blanks are surrounded with the plastic so that they can be arranged resting directly against the gas diffusion layer of the membrane. It is advantageous to select the formation of the plastic channels so that the gas does not come into direct contact with the metal plates. The metal plates either rest against the gas diffusion layer or are surrounded with plastic by means of injection molding. Because the channels are completely sealed with plastic, or are delimited by the membrane having the gas diffusion layers, towards the open side, no short circuit can occur.

It is advantageous to use a high-temperature plastic. For example, polyphenylene sulfide (PPS) may be used. By means of the use of a high-temperature plastic, which can permanently withstand temperatures of 180° C. to 260° C., for example, an advantageous area of use of the fuel cell is a heating system.

According to another preferred embodiment, the metal strips are configured as surface-treated metal strips. It is advantageous if the metal strips are gold plated. In this way, greater performance of the fuel cell is achieved. The surface treatment can be carried out, for example, in the form of a galvanic coating. This treatment is advantageously carried out after the punching process. Because the strips are still cohesive after the punching process, the advantage is obtained that all the strips, cohesively connected, can be surface-treated in a single work step, thereby again significantly reducing the costs for the production of the fuel cell.

By punching, the metal conductors may be made very narrow (down to approximately one millimeter). In this way, very small but nevertheless high-performance fuel cells for small devices can be produced. For example, it is possible to produce fuel cells for laptops, cameras, camcorders. It is also possible to produce very small, high-performance fuel cells for stationary uses, for example camping, mobile homes, as well as emergency power supplies (USV).

The production method according to the invention is characterized by the following advantages:
1. The conductor tracks are formed from a single metal sheet, complete and without waste.

2. The conductor tracks are displaced alternately towards the two sides of the punched blank or the punched band, and fixed in place there by being partially surrounded by plastic by means of injection molding.

3. The injection-molding die inserts, which are configured in comb shape, simultaneously form the cavities that later form the channels for the gas.

4. The metal conductors are pressed into their final position during the injection-molding process.

In this way, it is possible to form bipolar plates or electrode plates in a relatively inexpensive method.

The channels formed by the plastic have the advantage that they are configured to be completely smooth. This feature is another significant advantage as compared with the state of the art.

By folding the individual pairs of plates, it is possible to switch them electrically in series as well as in parallel. In a serial circuit, the strips are chained by way of the metal conductors. This arrangement has the advantage that no separate contacts are necessary. An individual pair of plates with a membrane arranged between the plates represents a so-called base element. These base elements can be switched in parallel. In other words, the pairs are individually arranged in the stack, in each instance. Each pair of plates is connected with one another by way of a conductor track that remains as a connection during the production of the plates.

In the case of the serial circuit, several cohesive pairs are stacked on top of one another. Here again, the connection exists because of the conductor tracks that are present in any case. No additional plug-in contacts are required.

The parallel circuit is advantageous in the case of smaller cells. In this case, the proportion of the pairs is greater. In this way, the fuel cell achieves a greater current intensity. The serial circuit is advantageously used for larger cells. Here, a greater voltage is obtained.

A combination of serial and parallel circuits is particularly advantageous, in order to achieve the current intensities and voltages that are required.

According to the invention, the punched band can be produced as an endless strand. The strand can be cut where required. As a result, the individual pairs can be cut apart. A group of four may be cut for a base element for a parallel circuit, for example. The outer pairs are folded, and a membrane having gas diffusion layers is arranged between them. In this way, a pair that forms a base element is obtained.

If the strand is treated galvanically, it is advantageous to cut this strand at approximately 1.20 meters, because this length is advantageous for a galvanic treatment. Without galvanic treatment, endless production is possible. In that case, the strand is cut only where required during the final assembly.

Two stacks that are made up of a serial circuit of electrodes can be switched in parallel, for example, in that the two like poles are connected with one another. As a result, the serial circuit and the parallel circuit as well as the combination can be achieved in the simplest possible manner, by means of folding.

When using bipolar plates, the current within a plate is passed directly from the top conductor tracks to the bottom conductor tracks.

Use of a seal that is injection-molded on results is the cell being gas-tight towards the outside. To the same extent, of course, it is also gas-tight towards the inside.

It is advantageous if the frame is injection-molded with a seal according to a two-component or 2K technique. According to the invention, however, there is also the possibility of using a flat seal as the seal.

In the case of the seal-that is injection-molded on, care must be taken to ensure that this seal is not exposed to excessive pressure during assembly of the stack. The seal is allowed to be exposed only to a certain pressure, since otherwise the seal would flow away. As a result, in this case, the seal would lose its sealing properties. The seal is formed only during the second injection-molding process. During the first injection-molding process, the two parts of a pair, that is the punched blanks of a pair, are separately surrounded by means of injection molding.

According to the method according to the invention, the seal is compressed only to the extent that the spacers of the plastic frame permit. In other words, a defined compression of the seal is obtained, so that the seal is not exposed to overly high pressure and therefore does not flow away. Because of the defined pressure, the seal has a correspondingly long useful lifetime. Therefore, according to the invention, a height reference is provided for the seal.

A location reference can also be provided. The location reference is achieved by means of projections that are injection-molded on and engage in recesses that are injection-molded onto adjacent plates, after assembly.

It is advantageous to use a plastic that demonstrates a certain adhesion to the metal. For this purpose, the plastic contains certain additives. In this way, the sealing effect is increased, so that the reaction agents cannot escape at the metal/plastic transition. Where there are projecting metal plates, because of the adhesion of the plastic to the metal, the result is also achieved that the plastic does not lift off from the metal plates in the outer region.

The fuel cell according to the invention furthermore demonstrates the following advantages:
1. The current transition from the membrane/electrode assembly/gas diffusion layer to the metal structure takes place with a low transition resistance.
2. The current and heat conduction takes place by way of well conducting-metal.
3. The flow field and the passages for the gas conduction are injection-molded out of plastic (temperature resistance>200° C.).
4. The low weight is achieved by means of a high plastic proportion and a low construction height.
5. The seal is injection-molded in the same process, using thermoplastic elastomer (TPE) or rubber (for example ethylene/propylene diene terpolymers (EPDM)).

By means of this combination, the design of the plates can be significantly simplified, thereby making their efficient production in a punching/injection-molding process possible.

According to the production method according to the invention, an in-line process, i.e. a production method in which all of the work steps are automated and take place directly one after the other, in terms of time and location, is used to punch, stamp and, if necessary, bend band material. The resulting punched bands are left in strips, in advantageous lengths. These bands then pass through other work steps, such as possible surface treatment, surrounding the punched bands with plastic by means of injection-molding, and injection-molding the seal on with thermoplastic elastomer.

To achieve good electricity and heat conduction, as well as good corrosion resistance, suitable metals and different surface treatments are used.

The connection between the electrode plates with one another by means of corresponding gates is utilized as an electrical conductor between two cells and/or for passing off the heat that is generated.

The progression of the channels in the flow field is arranged to be parallel between the plate planes that lie opposite one another. The two metal contact strips that lie directly opposite one another press down on the membrane/electrode assembly/gas diffusion layer from both sides.

The metal/plastic combination of the bipolar plates or electrode plates can also be configured in such a manner that the sheet metal is brought outward and the heat generated by means of an electrochemical reaction is passed off by way of a coolant, for example air (active and/or passive cooling).

Another advantage of the invention is that sealing the spaces for the reaction substances (for example hydrogen and oxygen or methanol) is significantly simplified:
In the case of the bipolar plate, the fuel and the oxidant are separated by means of plastic walls,
in the case of the electrode plate, only one medium, namely fuel or oxidant, is present in each individual cell between two membrane/electrode assemblies.

The electrode plates can be combined with one another as needed, during the injection-molding process, by means of separation points, both as a serial circuit and as a parallel circuit. The bipolar plates are assembled to form a stack in the case of a serial circuit and/or a parallel circuit of the membrane/electrode assembly/gas diffusion layer.

The electrode plates that have been connected with one another are folded on top of one another to form a stack during assembly with the membrane/electrode assembly/gas diffusion layer. In this way, it is not necessary to connect them electrically by way of connectors. Therefore the problem of contact corrosion, which is part of the state of the art, is avoided.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawing, wherein similar reference characters denote similar elements throughout the several views:

FIG. 1 is a longitudinal section through a stack of polar plates or electrode plates;

FIG. 2 is a detail of FIG. 1;

FIG. 3 is a cross-sectional view of an injection-molding die with metal strips arranged in the injection-molding die, before the injection-molding process;

FIG. 4 shows the injection-molding die according to FIG. 3 after the injection-molding process;

FIG. 5 is a cross-sectional view of an injection-molding die according to a modified injection-molding process;

FIG. 6, is a cross-sectional view of a fuel cell having two electrode plates;

FIG. 7 is a cross-sectional view of a fuel cell having two bipolar plates;

FIG. 8 shows a serial circuit of electrode plates;

FIG. 9 shows a parallel circuit of electrode plates.

### DETAILED DESCRIPTION OF PREFERRED EMBODIMENTS

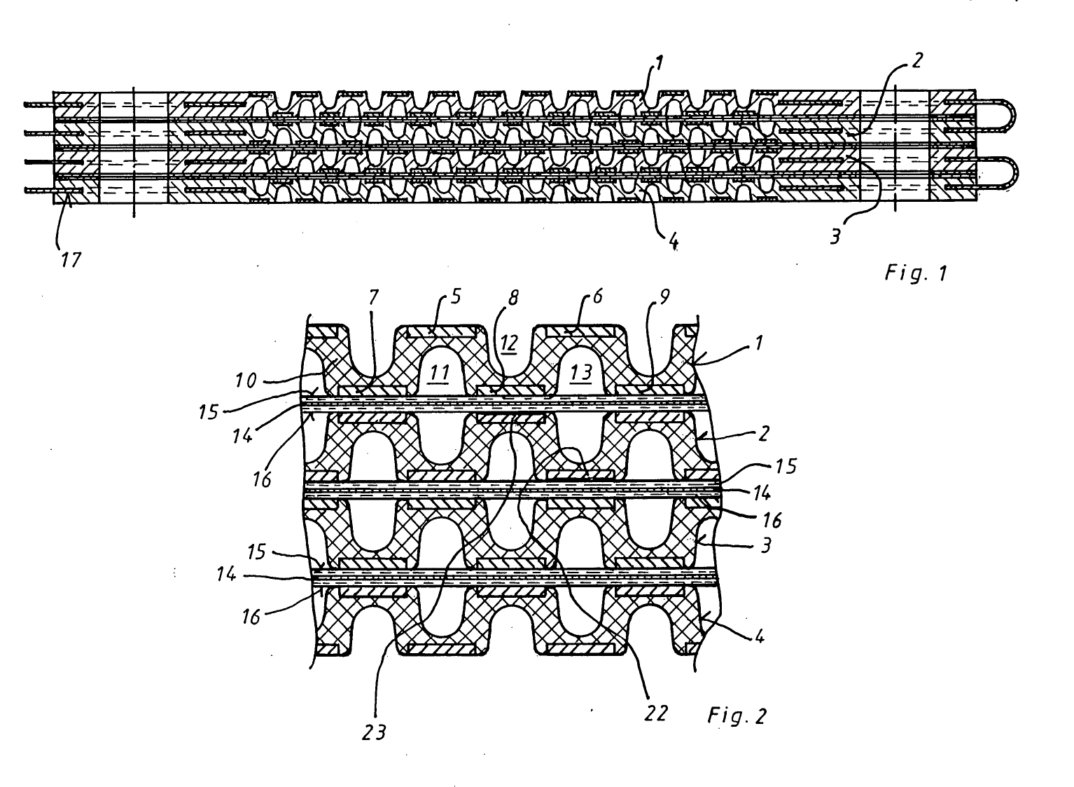

Referring now to the drawings, and in particular to FIGS. 1 and 2, bipolar plates or electrode plates 1, 2, 3, 4 are shown. Electrode plate 1 has metal strips 5 to 9, which were originally punched from a metal sheet. In the sheet, the metal strips 7, 5, 8, 6, 9 were arranged lying next to one another. By means of a plastic 10, channels 11, 12, 13 for the reaction gas or the reaction liquid not shown here are formed. A membrane 14 having gas diffusion layers 15, 16 is arranged between electrode plate 1 and electrode plate 2. Electrode plates 1, 2 are pressed onto gas diffusion layers 15, 16 with a certain contact pressure.

The differentiation between electrode plates or bipolar plates is based on how the reaction agents are carried in the channels. If, for example, hydrogen is carried in the channels of plate 1, i.e. in channels 11, 12, 13, while oxygen is carried in the channels of plate 2, plate 1 is an electrode plate.

If oxygen and hydrogen are alternately arranged in the channels, i.e. hydrogen in channel 11, oxygen in channel 12, and hydrogen again in channel 13, these plates are bipolar plates.

In FIG. 1, a cooling surface 17 is additionally shown.

FIG. 3 shows an injection-molding die 18 with inserts 19 in a bottom part and inserts 20 in a top part. The metal strips 5 to 9 are placed into the injection-molding die 18. Metal strips 5, 6 are pressed against top insert 20 of injection-molding die 18 by bottom insert 19 of injection-molding die 18. In the same way, metal strips 7, 8, 9 are pressed against bottom insert 19 of injection-molding die 18 by top insert 20. During the injection-molding process, top insert 20 and bottom insert 19 are moved in the direction of the double arrow A, so that the configuration of electrode plate 1 shown in FIG. 4 is formed.

According to FIG. 5, the metal strips 5, 6 are again arranged in injection-molding die 18. In the embodiment shown in FIG. 5, injection-molding die 18 is in the end position. The metal strips 5 to 9 are arranged in injection-molding die 18 at a slight distance from top part 20 and bottom part 19 of the die. Metal strips 5, 6 are pressed against top 20 and metal strips 7, 8, 9 are pressed against bottom 19 of injection-molding die 18 by injection-molding pressure, so that again, the electrode plate 1 shown in FIG. 4 is formed.

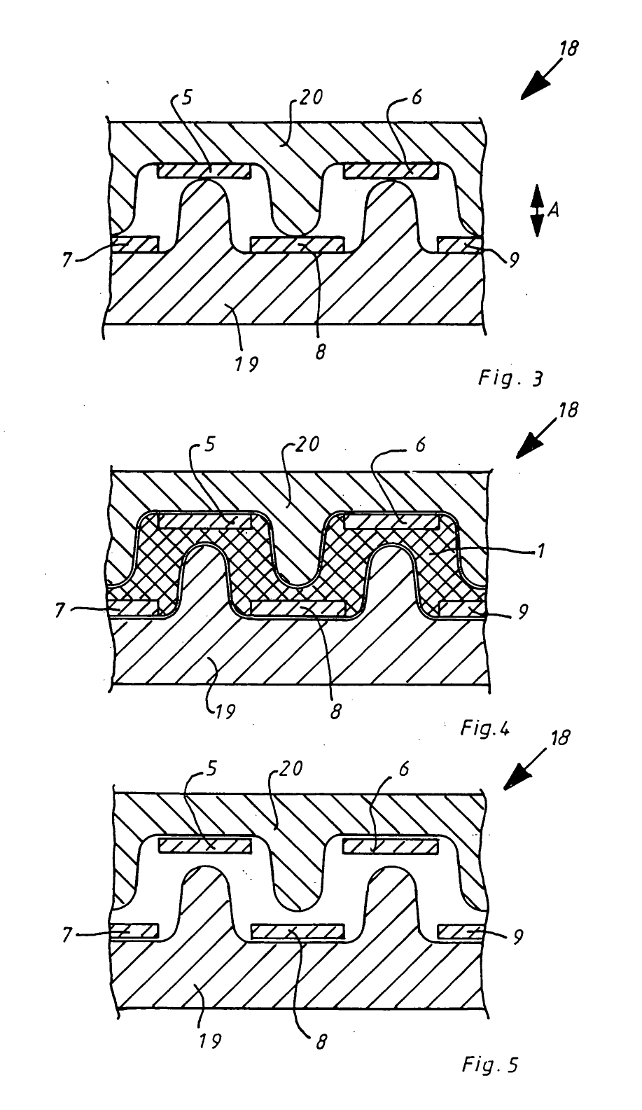

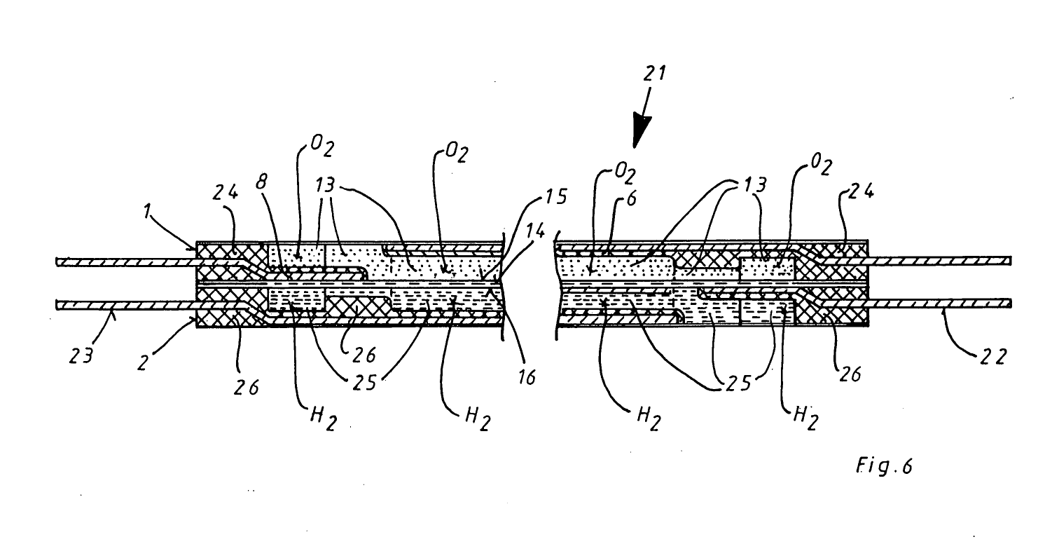

FIG. 6 shows a fuel cell 21 having two electrode plates 1, 2. Electrode plate 1 has the metal strips 6, 8 that serve as conductor tracks. Electrode plate 2 has the conductor tracks 22, 23. In the edge region of fuel cell 21, a plastic seal 24 is injection-molded on. Oxygen (O₂) is conducted by the channels 13 of electrode plate 1, while hydrogen (H₂) is conducted by the channels 25 of electrode plate 2. The gas diffusion layers 15, 16 with the membrane 14 lying between them are arranged between electrode plates 1, 2. Conductor track 23 is surrounded by plastic 26 by means of injection molding; this plastic simultaneously forms channel 25.

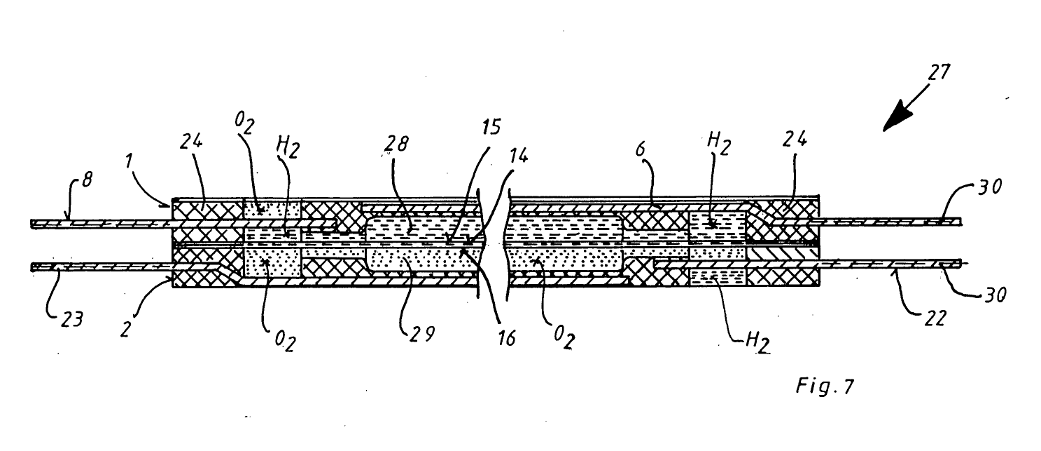

According to FIG. 7, the fuel cell 27 having the electrode plates 1, 2 is shown; again, electrode plates 1, 2 have conductor tracks 6, 8; 22, 23. The gas diffusion layers 15, 16 with the membrane 14 lying between them are arranged between electrode plates 1, 2. In the fuel cell 27 shown in FIG. 7, channels 28, 29 are formed. Hydrogen (H₂) is conducted by means of channel 28, while oxygen (O₂) is conducted by channel 29. Fuel cell 27 also has a plastic seal 24. Projecting metal plates 30 serve to pass off heat into a non-conductive cooling medium not shown.

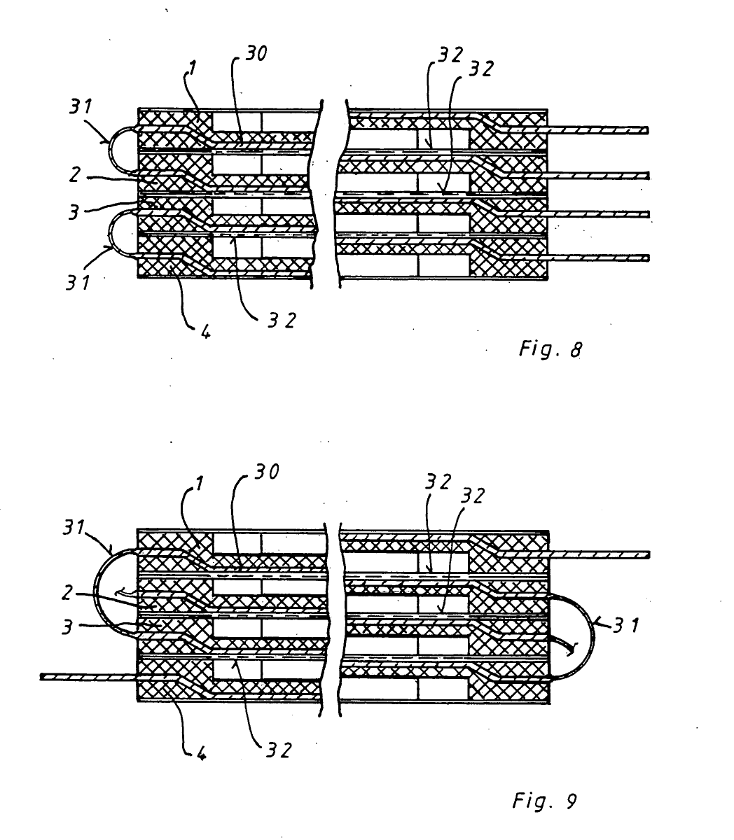

For a fundamental explanation of the serial circuit, a serial circuit of electrode plates is shown in FIG. 8. The electrode plates 1, 2 form a pair, as do the electrode plates 3, 4. In order to make a serial circuit possible, it is necessary for the two conductor tracks (for example contact surfaces 5, 7 in FIG. 2) to be electrically insulated from one another. However, the conductor tracks have an electrical connection to the next electrode plate of the same electrode pair 1, 2 (for example contact surface 5 with contact surface 23 and contact surface 7 with contact surface 22 in FIG. 2). A gas diffusion layer with membrane 32 is arranged between electrode plates 1, 2 and electrode plates 3, 4, as well as between the pairs, in each instance.

FIG. 9 shows a parallel circuit having the electrode plates 1, 2; 3, 4 with the gas diffusion layers with membranes 32 arranged between them, in each instance. For the parallel circuit, the two conductor tracks (for example contact surfaces 5, 7 of FIG. 2) are electrically connected. Electrode plate pairs 1, 3 are electrically connected with one another by way of the conductor track or continuous sheet-metal strand 31. Electrode plate pairs 2, 4 are electrically connected with one another by way of the conductor track or continuous sheet-metal strand 31 (shown on the right in FIG. 9).

Although only a few embodiments of the present invention have been shown and described, it is to be understood that many changes and modifications may be made thereunto without departing from the spirit and scope of the invention as defined in the appended claims.

1. A method for producing bipolar or electrode plates for fuel cells or electrolyzer stacks comprising the steps of:
(a) cutting a flat material comprising a conductive and corrosion-resistant material into at least one strip using a punching process;
(b) pushing out the at least one strip from a center position to form at least one punched band or at least one punched blank; and
(c) carrying out an injection-molding process so that the at least one punched band or the at least one punched blank is held in place by plastic.

2. The method according to claim 1, wherein the at least one punched band or the at least one punched blank surrounded with plastic, by means of injection molding, so that channels for passing through reaction agents are formed with the plastic.

3. The method according to claim 1, wherein the at least one strip is merely partially incised during the punching process or connection gates are formed.

4. The method according to claim 1, wherein during the injection-molding process, the at least one strip is pushed into an end position and partially surrounded there, by means of injection molding.

5. The method according to claim 1, wherein the at least one strip is brought into an end position by means of injection-molding pressure or by means of movable inserts of an injection-molding die, during the injection-molding process.

6. The method according to claim 1, wherein channels for carrying reaction agents are pre-formed or completely formed in a working region of at least one punched blank or the at least one punched band.

7. The method according to claim 1, wherein after the punching process and before the injection-molding process, a surface treatment of the at least one punched blank or the at least one punched band is carried out.

8. A method for producing a stack of bipolar plates or electrode plates comprising the steps of:
(a) cutting a flat material comprising a conductive and corrosion-resistant material into strips using a punching process;
(b) pushing out the strips from a center position to form a plurality of punched bands or punched blanks;
(c) carrying out an injection-molding process so that the punched bands or punched blanks are held in place by plastic; and
(d) arranging at least one membrane carrying a gas diffusion layer between the punched blanks or punched bands.

9. The method according to claim 8 further comprising the step of arranging a progression of channels in a flow field to be parallel between plate planes that lie opposite one another, so that two metal strips that lie opposite one another or are passed crosswise, and are formed from the band material and partially surrounded with plastic by means of injection-molding, in each instance, are arranged to rest with pressure on both sides of the at least one membrane carrying the gas diffusion layer.

10. The method according to claim 9, wherein a plastic frame with seal is injection-molded onto the punched bands or the punched blanks.

11. The method according to claim 8, wherein the bipolar plates or electrode plates are arranged to form a serial circuit or a parallel circuit in the stack.

12. The method according to claim 8, wherein the stack is built up by lining up identical segments, wherein one segment of an electrode plate comprises distributor channels and connectors for reaction agents and a membrane/electrode assembly (MEA), whereby the membrane/electrode assembly of an nth segment forms a gas-tight and electrically insulating but proton-conductive delimitation of an (n+1)^{th} segment, and the membrane/electrode assembly of the (n+1)^{th} segment forms a gas-tight and electrically insulating but proton-conductive delimitation of an (n+2)^{th} segment where n is an integer or whole number.

13. The method according to claim 8, wherein end plates are arranged at both ends of the electrode stack, between which individual lined-up segments with their seals are clamped, said end plates having connectors for passing reaction agents in and out.

14. A bipolar plate or electrode plate comprising at least one punched band or at least one punched blank having strips of punched flat material comprising a conductive and corrosion-resistant material, said at least one punched band or said at least one punched blank being partially surrounded by plastic by means of injection molding to form channels for reaction agents.

15. The plate according to claim 14, wherein the at least one punched band or the at least one punched blank is formed from stainless steel or copper, with a corrosion protection layer.

16. The plate according to claim 14, wherein the at least one punched band or the at least one punched blank has an opening for passing through reaction agents.

17. The plate according to claim 14, wherein the strips comprise surface-treated metal strips.

18. The plate according to claim 14, wherein the strips are insulated from said channels for reaction agents.

19. The plate according to claim 14, wherein polyphenylene sulfide (PPS) is used as the plastic.

20. The plate according to claim 14, further comprising corresponding connectors, connections, and cross-sections for use of the plate as a fuel cell with hydrogen gas or liquid or gaseous substances.

21. The plate according to claim 20, wherein the connectors, connections, and cross-sections are designed for use as an electrolyzer.

22. The plate according to claim 14, wherein a high-temperature plastic is used as the plastic.
